(19) United States
(12) Patent Application Publication
(10) Pub. No.: US 2007/0180773 A1
(43) Pub. Date: Aug. 9, 2007

(54) Dual-guided single rail window regulator

(76) Inventors: Raymond Edward Fortin, Ontario (CA); Luc R. Regnier, Ontario (CA)

Correspondence Address: MAGNA INTERNATIONAL, INC., 337 MAGNA DRIVE, AURORA, ON, L4G-7K1, CA

(21) Appl. No.: 11/573,211

(22) PCT Filed: Aug. 5, 2005
(86) PCT No.: PCT/CA05/01212

§ 371 Date: Feb. 6, 2007

Related U.S. Application Data
(60) Provisional application No. 60/599,627, filed on Aug. 6, 2004.

(51) Int. Cl. E05F 11/48

(52) U.S. Cl. 49/352

(57) ABSTRACT

A single rail window regulator that uses a plate with two spaced, parallel guides that are integral to the plate. A lift member, adapted to receive a window pane, is slidably coupled to both guides. A cable is wrapped around two opposing pulleys that are mounted on the plate and a cable drum that is coupled a drive system. The ends of the cable are attached to the lift member. Activating the drive system moves the lift member along the rails.

### FIELD OF THE INVENTION

The present invention relates to window regulators for automotive vehicles. More specifically, the present invention relates to a single rail window regulator having a lift member that is slidably mounted to both sides of the rail.

### BACKGROUND OF THE INVENTION

A wide variety of window regulators have been developed to raise or lower door windows in vehicles. Two popular types of window regulator are single rail window regulators and dual rail window regulators. Single rail window regulators typically have a lift member that is slidably mounted on a rail inside the vehicle door frame. The window pane is mounted on the lift member. A drive system, powered by either an electric motor or a hand crank, moves the lift member along the rail, raising or lowering the window. Dual rail window regulators are similar to single rail window regulators, but use two parallel, spaced-apart rails instead of one. A dual rail window regulator typically uses two lift members, where a lift member is attached to each rail, or it can use one lift member that spans between the two rails.

However, dual rail window regulators are not without their drawbacks. For example, dual rail window regulators to date have been relatively complex to manufacture. Each rail is manufactured separately and then assembled as part of the window regulator, increasing costs. Additionally, the lift member or members must then be connected to the drive system by a complex arrangement of pulleys and cables. Existing dual rail window regulator can be bulky and difficult to install in the vehicle frame. Furthermore, dual rail systems must ensure that the lift member or members are synchronized to be level and move in parallel. Routine use of the window regulator can misalign the lift member or members, decreasing stability for the window pane.

It is therefore desired to provide a single rail window regulator that provides a greater reliability and is easier and less expensive to manufacture and install than conventional dual rail window regulators.

### SUMMARY OF THE INVENTION

It is an object of the present invention to provide a novel single rail window regulator that obviates or mitigates at least some of the above-identified disadvantages of the prior art.

According to a first aspect of the present invention, there is provided a window regulator for moving a window pane, comprising:
a plate having two integral, spaced apart, guides;
a lift member for mounting a window pane, the lift member extending between and being slidably coupled to each guide; and
a drive system for moving the lift member along the two guides. According to another aspect of the present invention, there is provided a
a plate having two integral, spaced apart, guides;
a lift member for mounting a window pane, the lift member extending between and being slidably mounted to each guide;
a first pulley and a second pulley mounted to the plate in opposing relationship between the two guides;
a cable drum mounted to the plate between the two guides and between the first pulley and the second pulley;
drive means for rotating the cable drum; and
a cable attached to the lifting member, the cable being routed around the first pulley, the second pulley, and the cable drum so that rotating the cable drum moves the lift plate transversely along the two guides towards one of the first pulley and the second pulley.

The present invention provides a single rail window regulator that uses two spaced, parallel guides that are integrally formed in a plate. A lift member, adapted to receive a window pane, is slidably coupled to both guides. A cable is wrapped around two opposing pulleys that are mounted on the plate and a cable drum that is coupled a drive system. The ends of the cable are attached to the lift member. Activating the drive system moves the lift member along the rails towards one of the two opposing pulleys. The invention can accommodate both electric and manual drive systems.

### BRIEF DESCRIPTION OF THE DRAWINGS

Preferred embodiments of the present invention will now be described, by way of example only, with reference to the attached Figures, wherein:

FIG. 1 shows an isometric front view of a window regulator in accordance with a first embodiment of the invention;

FIG. 2 shows an isometric rear view of a window regulator of the embodiment shown in FIG. 1;

FIG. 3 shows an exploded plan view of a ferrule housing used on the window regulator shown in FIGS. 1 and 2;

FIG. 4 shows an isometric front view of a window regulator in accordance with an alternate embodiment of the invention; and

FIG. 5 shows an isometric rear view of the window regulator shown in FIG. 4.

### DETAILED DESCRIPTION OF THE INVENTION

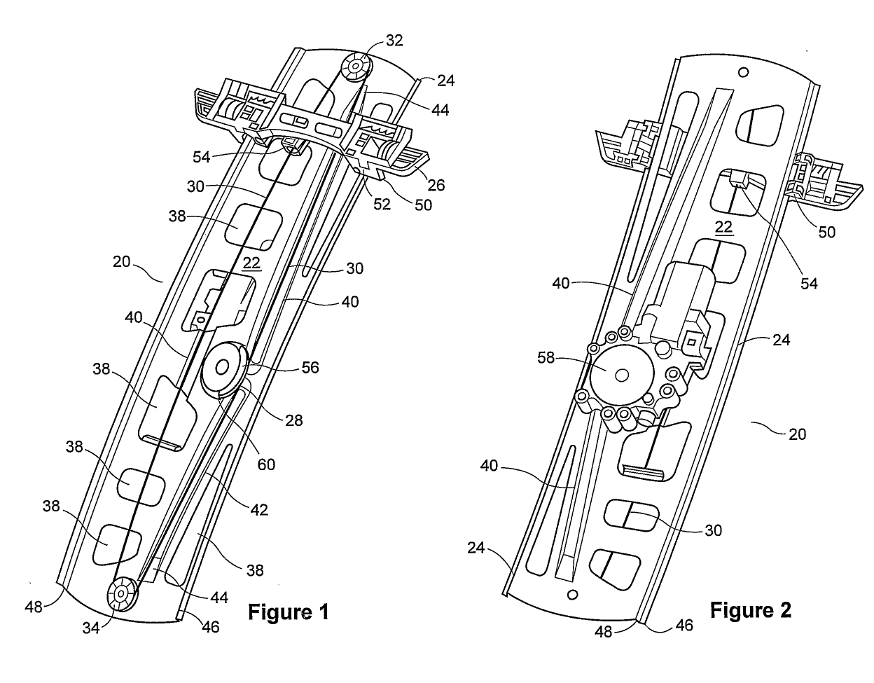

Referring now to FIGS. 1 and 2, an embodiment of the invention is shown with reference to 20. Window regulator 20 comprises a plate 22 with two horizontally spaced, integral guides 24. A lift member 26 is slidably coupled to both guides 24 and is adapted to mount a wmdow pane (not shown). A drive 28, mounted to plate 22, is operable to raise or lower lift member 26 via a cable 30 that is wrapped around an opposing first pulley 32 and a second pulley 34. The two ends (not shown) of cable 30 are secured to lift member 26. Activating drive 28 pulls lift member 26 along guides 24 towards one of first pulley 32 and second pulley 34. The length of guides 24 between first pulley 32 and second pulley 34 defines a range that the window pane can be raised or lowered.

Plate 22 presents a front surface and a rear surface. Plate 22 is preferably formed from a unitary piece of metal or plastic and can be manufactured by conventional casting, stamping or roll forming techniques. Plate 22 is attached to a substructure (not shown) of a vehicle door frame via conventional fasteners. Alternatively, plate 22 can be attached to or otherwise formed as part of the substrate of a door hardware module to a vehicle door frame. Preferably, plate 22 includes a number of voids 38 that reduce the weight of and material required for plate 22. Plate 22 also preferably includes one or more cable channels 40 that are integrally formed in the front surface of plate 22 and run under at least a portion of the path of cable 30. Cable channels 40 can include raised sidewalls 42 to provide additional protection for cable 30. Additionally, cable channels 40 can include ramps 44 to provide additional guidance for cable 30.

As previously described, two spaced parallel guides 24 are integrally formed from opposite edges of plate 22 and run longitudinally along plate 22. In the embodiment referred to in FIGS. 1 and 2, guides 24 run fully across the length of plate 22. Guides 24 can also be shorter than the full length of plate 22. Both guides 24 and plate 22 may be curved as to provide an arcuated path for a window pane. While the embodiment referred to in FIGS. 1 and 2 has the two guides 24 positioned at opposite edges of plate 22, the inventors have determined that parallel guides 24 can also be formed in portions of plate 22 that are not at the plate edges.

Preferably, each guide 24 includes a flange portion 46 and a web portion 48. Flange portion 46 is adapted to receive a complementary structure on lift member 26, thus preventing lift member 26 from detaching from guide 24 when plate 22 is aligned in a vertical position. The shape of flange portion 46 is not particularly limited and can be flat, curved, or grooved. Other shapes for flange portion 46 will occur to those of skill in the art. Additionally, the two guides 24 can have non-symmetrical flange portions 46. Web portion 48 displaces flange portion 46 away from the front surface of plate 22. In the current embodiment, web portion 48 is substantially perpendicular to plate 22. However, web portion 48 can also be formed at a non-perpendicular angle to plate 22. Additionally, while in the illustrated embodiment, web portion 48 displaces flange portion 46 away from the front surface of plate 22, web portion 48 can also displace flange portion 46 away from the rear surface of plate 22. Other variations on web portion 48 will occur to those of skill in the art.

As previously described, lift member 26 is a continuous piece that extends between and is slidably coupled to both guides 24. Lift member 26 is suitably adapted to mount a window pane (not shown). In the present embodiment, each lift member 26 is slidably coupled to each guide 24 using an integral slider 50. Each slider 50 is complementary to the guide 24 so as to allow lift member 26 to slide along guides 24. Each slider 50 is also complementary to flange portion 46, thus preventing lift member 26 from accidentally detaching from guides 24 when plate 22 is aligned in a vertical position. Preferably, each slider 50 uses rail bushings 52 to provide smoother motion along guides 24 and reduce wear and tear.

The lift member 26 is attached to each end of cable 36 via a ferrule housing 54. Preferably, ferrule housing 54 is integrally formed in lift member 26 in the span between the two guides 24. Cable ends 36 and ferrule housing 54 are described in greater detail below.

In the embodiment shown in FIGS. 1 and 2, drive 28 comprises a cable drum 56 that is coupled with an electric motor 58. Cable drum 56 is rotatably mounted to the front surface of plate 22 and electric motor 58 is mounted to the rear surface of plate 22. Electric motor 58 is operable to rotate cable drum in both a clockwise and a counterclockwise direction. Preferably, cable drum 56 is at least partially recessed in a drum housing 60 that is formed from a concave depression in the front surface of plate 22 thus reducing the overall thickness of window regulator 20.

First pulley 32 is rotatably mounted to the front surface of plate 22 near a first end of plate 22. Preferably, first pulley 32 is mounted equidistant between guides 24. Second pulley 34 is rotatably mounted to the front surface of plate 22 near an opposite end of plate 22. Preferably, second pulley 34 is mounted equidistant between guides 24. As can be clearly seen from FIG. 1, drive 28 is disposed between first pulley 32 and second pulley 34, and is closer to second pulley 34 than to first pulley 32. Cable 30 is wrapped around cable drum 56, first pulley 32 and second pulley 34. Cable 30 is secured at both cable ends 36 within ferrule housing 54, so that engaging drive 28 pulls lift member 26 towards one of first pulley 32 and second pulley 34.

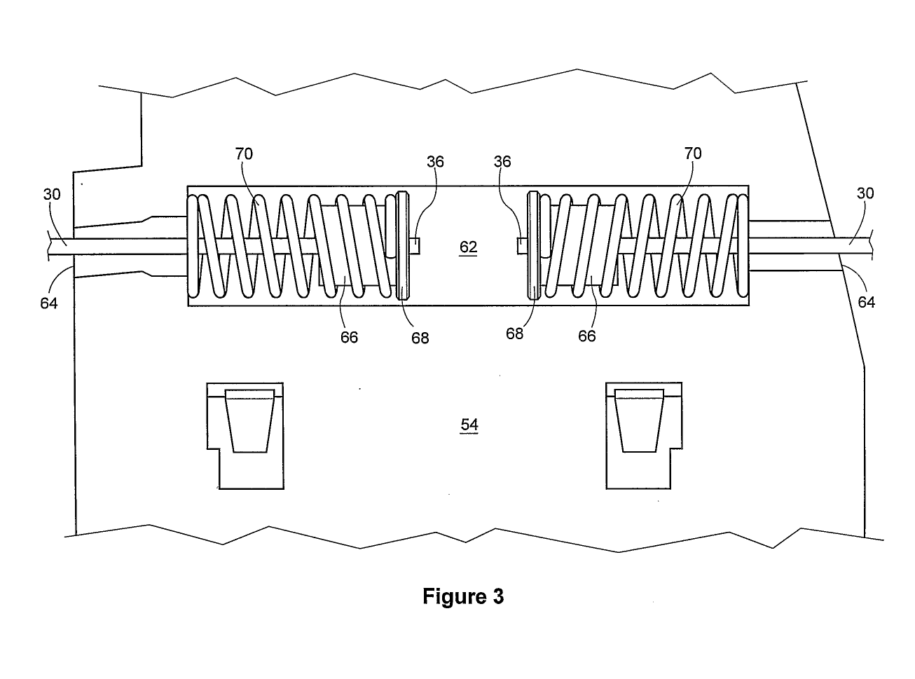

Referring now to FIG. 3, cable ends 36 and ferrule housing 54 are shown in greater detail. Ferrule housing 54 forms a generally rectangular box, having an interior chamber 62. Two opposite openings 64 each define a passageway from chamber 62 to outside ferrule housing 54 that is parallel to guides 24. Cable 30 runs through openings 60 into chamber 62. Within chamber 62, a cylindrically shaped ferrule 66 is secured over cable 30 near each cable end 36. Each ferrule 66 possesses a larger diameter than opening 64 so that cable end 36 cannot exit chamber 62 through opening 64. Ferrules 66 can be made of any suitably resilient material. Each ferrule 66 has a ferrule flange 68 extending outwards from a portion of ferrule 66. A helical spring 70 is coiled around cable 30 and ferrule 66. Helical spring 70 abuts both the interior wall of ferrule housing 54 and ferrule flange 68. Thus, when a cable end 36 is pulled towards first pulley 32 or second pulley 34 by drive 28, helical spring 68 is compressed, transferring force against the interior wall of ferrule housing 54 and moving lift member 26 along guides 24. Friction, adhesive or the like between ferrule 66 and cable 30 maintains the distance of ferrule 66 from cable end 36, maintaining the desired tension on cable 30.

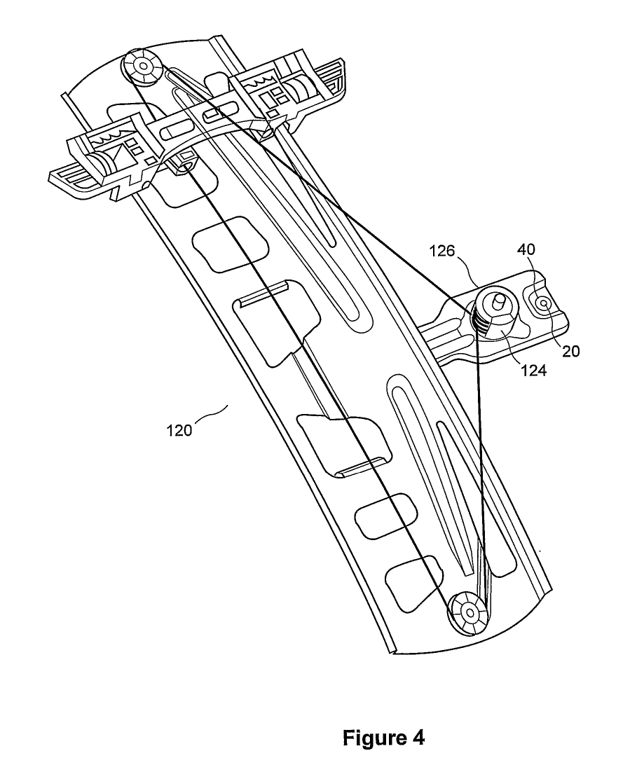

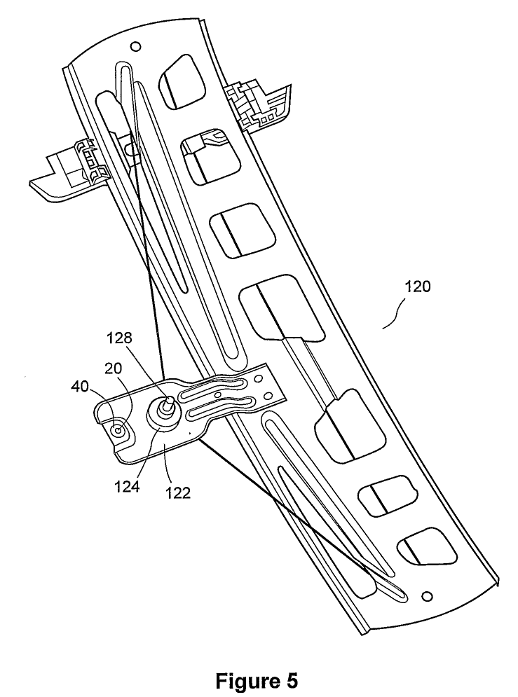

Referring now to FIGS. 4 and 5, an alternate embodiment of the invention is shown with reference to window regulator 120. Window regulator 120 is adapted for a manual door window and includes a drum arm 122 that is fastened to the rear surface of plate 22 by conventional means and extends away from plate 22 on a parallel plane. Manual drive 124 is mounted to drum arm 122 and includes a cable drum 126 that is coupled to a shaft 128. Shaft 128 is further coupled with a hand crank (not shown). Between first pulley 32 and cable drum 126 and between second pulley 34 and cable drum 126, cable 30 is threaded through voids 38. While the embodiment shown with reference to FIGS. 4 and 5 mounts manual drive 124 to drum arm 122, those of skill in the art will recognize that manual drive 124 can also be mounted onto a sufficiently wide plate 22.

While the embodiments discussed herein are directed specific embodiments of the invention, it will be understood that combinations, sub-stets and variations of the embodiments of the invention are within the scope of the invention. For example, it has been contemplated that one or both of first pulley 32 and second pulley 34 could be replaced with integral molded cylindrical sliders. Other variations of the invention are also contemplated. For example, one or more additional guides 24 could be added to plate 22 along with one or more additional complementary slider 50 to provide for further stability for lift member 26. Other variations on guides 24 will occur to those of skill in the art. The above-described embodiments of the invention are intended to be examples of the present invention and alterations and modifications may be effected thereto, by those of skill in the art, without departing from the spirit of the invention.

What is claimed is:

1. A window regulator for moving a window pane in an automotive door, comprising:
a plate having two integral, spaced apart, guides;
a lift member for mounting a window pane, the lift member extending between and being slidably coupled to each guide; and
a drive for moving the lift member.

2. A window regulator according to claim 1, wherein the drive comprises:
a first pulley and a second pulley mounted in opposing relationship between the two guides;
a cable drum mounted to the plate between the two guides and between the first pulley and the second pulley;
drive means for rotating the cable drum;
a cable attached to the lifting member, the cable being routed around the first pulley, the second pulley, and the cable drum so that rotating the cable drum moves the lift plate transversely along the two guides towards one of the first pulley and the second pulley.

3. The window regulator of claim 2, where the drive means is an electric motor coupled with the cable drum.

4. The window regulator of claim 2, where the drive means is a manual winch coupled with the cable drum.

5. The window regulator of claim 1, where a drum housing is formed from a depression in a planar surface of the plate, and the cable drum is mounted in the drum housing.

6. The window regulator of claim 2, where at least one cable channel is a depression integrally formed in a planar surface of the plate, and the cable runs through the at least one cable channel.

7. The window regulator of claim 6, where the at least one cable channel includes raised sidewalls along at least a portion of at least one edge of the at least one cable channel, the raised sidewalls integrally formed and extending outwards generally perpendicularly from the surface of the plate.

8. The window regulator of claim 6, where the at least one cable channel includes at least one ramp portion, the ramp portion sloped towards at least one of the first pulley, the second pulley, and the cable drum.

9. The window regulator of claim 1, where the plate is a unitary piece of molded plastic.

10. The window regulator of claim 1, where the window regulator attaches within a substructure casing to form a sealed module for the automotive door.
